(19) United States
(12) Patent Application Publication
(10) Pub. No.: US 2008/0223686 A1
(43) Pub. Date: Sep. 18, 2008

(54) WET TYPE FRICTION PLATE

(76) Inventor: Hiroyuki KINPARA, Fukuroi-shi (JP)

Correspondence Address: MILES & STOCKBRIDGE PC, 1751 PINNACLE DRIVE, SUITE 500, MCLEAN, VA, 22102-3833, US

(21) Appl. No.: 12/048,200

(22) Filed: Mar. 13, 2008

(30) Foreign Application Priority Data
Mar. 16, 2007 (JP) 2007-068556

(51) Int. Cl. F16D 13/64

(52) U.S. Cl. 192/107 R

(57) ABSTRACT

The present invention provides a wet type friction plate having a friction surface formed by fixing a friction material to a substantially annular core plate in an annular arrangement, in which a plurality of grooves extending through from an inner diameter portion to an outer diameter portion is formed in the friction surface and at least one of both side portions of the friction material defining the groove is formed as an arc configuration and the groove has a radial intermediate portion having a width greater than those of the inner diameter portion and the outer diameter portion.

### BACKGROUND OF THE INVENTION

1. Field of the Invention

The present invention relates to a wet type friction plate used in a speed change clutch, a lock-up clutch for a torque converter, a wet type multi-plate clutch for a starting clutch and the like utilized in a clutch or a brake and the like of an automatic transmission (AT) of a vehicle.

2. Description of the Related Art

In general, in a wet type multi-plate clutch, friction plates and separator plates are disposed alternately between a drum and a hub of a clutch or a brake so that the clutch is engaged and disengaged by applying to and releasing from a force with respect to the plates by means of a clutch piston, respectively.

Further, in recent years, low fuel consumption of a motor vehicle has been requested more and more, and, also in an automatic transmission, reduction in drag torque between the friction plate and the separator plate has been requested more and more in order to reduce power loss during the disengagement.

A wet type multi-plate clutch including paper friction materials has advantages that a transmission torque can be controlled by adjusting a load applied to a friction surface and that smooth engagement can be achieved during transmission of the torque and is mainly used in a speed change device of the automatic transmission, a torque converter, a starting clutch and the like.

In general, in many cases, a wet type multi-plate clutch used in an automatic transmission (AT) is designed so that lubricating oil can easily been flown from an inner peripheral side to an outer peripheral side of the friction plate, thereby reducing the drag torque. Such arrangements for reducing the drag torque are known, for example, as disclosed in Japanese Patent Application Laid-open Nos. 11-141570 (1999) and 2005-76759. In the clutches disclosed in the Japanese Patent Application Laid-open Nos. 11-141570 (1999) and 2005-76759, the friction plate is provided with oil grooves each having a closed end at an inner peripheral side to separate the friction plate and the separator plate during the disengagement and oil passages extending through from an inner periphery to an outer periphery in a radial direction and adapted to supply oil in order to prevent seizure during the engagement by supplying the lubricating oil to the friction surfaces

However, in recent years, in order to improve speed change response so as to enhance power performance as well as the reduction in fuel consumption, a clearance between the friction plate and the separator plate has been made narrower than that in the prior art, with the result that the drag torque tended to increase during an idle rotation due to the presence of the interposed oil film.

Further, in order to meet the requirement for reducing the reduction in fuel consumption, recently, as a countermeasure for providing an automatic transmission of compact size and/or multi-stage type and providing an oil pump of compact size and achieving excellent efficiency by reducing drag torques of sliding elements, the friction plate utilized in the automatic transmission has been designed to be used with higher rotation and a smaller amount of the lubricating oil, and thus, a wet type friction plate having greater heat resistance has been requested in the case where the friction plate is used with the smaller amount of the lubricating oil and the higher rotation.

Although the oil from the oil groove extending through from the inner periphery to the outer periphery in the radial direction is used to supply the oil to the friction surface and to discharge the oil, the flow of the oil from the oil groove to the friction surface is greatly influenced by a configuration of the oil groove and the like, with the result that the oil flow affects an influence upon the idle rotation torque and the friction property during the engagement, thereby causing dispersion in plate quality.

In the conventional friction plates, in order to meet the requirements for compactness and light-weight which should be achieved in the recent transmissions, it has been desired to increase friction capacity of each friction plate. To this end, the increase in the number of grooves to be formed in the friction plate and the size of the groove has been limited or restricted severely.

In the conventional straight configuration of the groove as disclosed in the above-mentioned Japanese Patent Application Laid-open Nos. 11-141570 (1999) and 2005-76759, the groove could not provide a sufficient negative pressure effect to take in the lubricating oil. Further, the lubricating oil in the groove was hard to be supplied to the friction surface efficiently, and a great amount of the lubricating oil was discharged from the groove to the outside without passing through the friction surface.

### SUMMARY OF THE INVENTION

Accordingly, an object of the present invention is to provide a wet type friction plate which can lubricate a friction engagement surface effectively even with a small amount of supplied oil and which has excellent heat-resistance.

To achieve the above object, the present invention provides a wet type friction plate having a friction surface formed by securing a friction material to a substantially annular core plate in an annular arrangement, in which a plurality of grooves extending through from an inner diameter portion to an outer diameter portion is formed in the friction surface and at least one of both side portions of the friction material defining the groove is formed as an arc configuration and the groove has a radial intermediate portion having a width greater than those of the inner diameter portion and the outer diameter portion.

According to the present invention, the following advantages can be obtained.

Since the width of the groove configuration is increased from the inner and outer diameter portions of the friction surface to the intermediate portion in the arc fashion, as the number of rotations or revolutions is increased, negative pressure is generated in the groove thereby to take in lubricating oil from the inner diameter portion or the outer diameter portion into the groove, and the taken-in lubricating oil is supplied from the groove to the friction surface effectively, thereby efficiently eliminating friction heat generated upon the engagement of the clutch.

Further, in association with a lubricating path, by increasing a width of an opening portion of the inner diameter portion more than a width of an opening portion of the outer diameter portion in a case where an amount of the lubricating oil taken in from the inner diameter portion is desired to be increased, and, by increasing the width of the opening portion of the outer diameter portion more than the width of the opening portion of the inner diameter portion in a case where an amount of the lubricating oil taken in from the outer diameter portion is desired to be increased, the friction surface can be lubricated more effectively.

Further, by designing the groove to be inclined with respect to a rotational direction of the wet type friction plate, the effect can be more increased.

Further features of the present invention will become apparent from the following description of exemplary embodiments with reference to the attached drawings.

### BRIEF DESCRIPTION OF THE DRAWINGS

FIG. 1 is a partial axial sectional view of a wet type multi-plate clutch in which various embodiments of a wet type friction plate of the present invention can be used.

FIG. 2 is a front view of a wet type friction plate according to a first embodiment of the present invention.

FIG. 3 is a front view of a wet type friction plate according to a second embodiment of the present invention.

FIG. 4 is a front view of a wet type friction plate according to a third embodiment of the present invention.

FIG. 5 is a front view of a wet type friction plate according to a fourth embodiment of the present invention.

FIG. 6 is a front view of a wet type friction plate according to a fifth embodiment of the present invention.

FIG. 7 is a front view of a wet type friction plate according to a sixth embodiment of the present invention.

FIG. 8 is a front view of a wet type friction plate according to a seventh embodiment of the present invention.

### DESCRIPTION OF THE EMBODIMENTS

Now, the present invention will be fully described with reference to the accompanying drawings. Incidentally, in the drawings, the same parts or elements are designated by the same reference numerals.

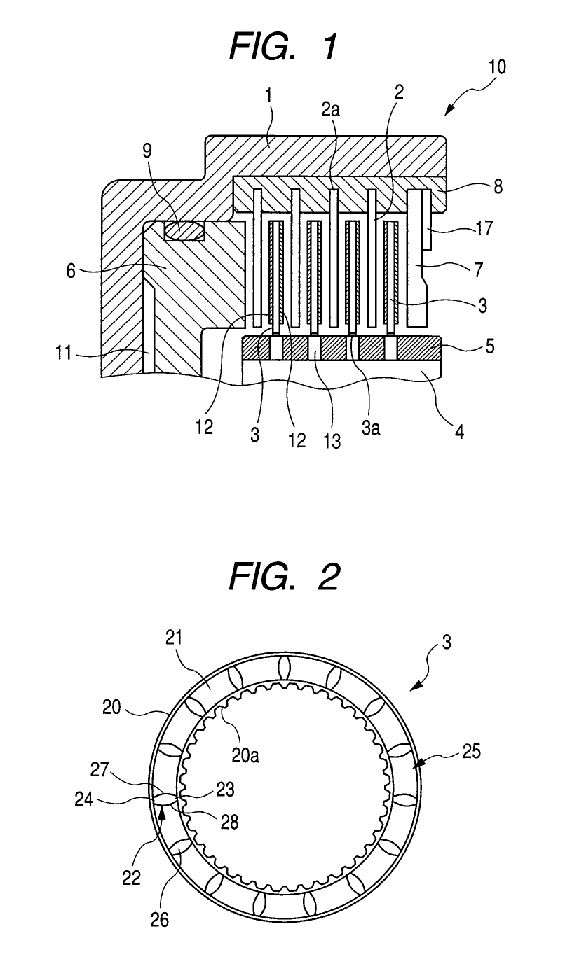

FIG. 1 is a partial axial sectional view of a wet type multi-plate clutch 10 in which various embodiments of a wet type friction plate of the present invention can be used.

The wet type multi-plate clutch 10 comprises a substantially cylindrical drum or clutch case 1 having an opened axial one end, a hub 4 disposed coaxially within the clutch case 1 and rotatable relative to the clutch case, a plurality of annular separator plates 2 disposed, for an axial movement, in a spline portion 8 provided on an inner periphery of the clutch case 1 and a plurality of annular friction plates 3 disposed in a spline portion 5 provided on an outer periphery of the hub 4 and arranged alternately with the separator plates 2 in an axial direction. Plural separator plates 2 and friction plates 3 are provided.

The wet type multi-plate clutch 10 includes a piston 6 for urging the separator plates 2 and the friction plates 3 to engage these plates with each other, a backing plate 7 provided on the inner periphery of the clutch case 1 to fixedly hold the separator plates 2 and the friction plates 3 at an axial one end of the clutch, and a stop ring 17 for holding the backing plate.

As shown in FIG. 1, the piston 6 is slidably disposed within a closed end portion of the clutch case 1. An O-ring 9 is disposed between an outer peripheral surface of the piston 6 and an inner surface of the clutch case 1. Further, a seal member (not shown) is also provided between an inner peripheral surface of the piston 6 and an outer peripheral surface of a cylindrical portion (not shown) of the clutch case 1. Accordingly, an oil-tight hydraulic chamber 11 is defined between an inner surface of the closed end portion of the clutch case 1 and the piston 6.

In each of the friction plates 3 held by the hub 4 for the axial sliding movement, friction materials 12 having predetermined coefficient of friction are stuck to both surfaces of the friction plate. However, the friction material may be provided on only one surface of the friction plate 3 and/or the separator plate 2. Further, the hub 4 is provided with lubricating oil supplying ports 13 extending through in a radial direction so that lubricating oil is supplied from an inner diameter side to an outer diameter side of the wet type multi-plate clutch 10.

In the wet type multi-plate clutch 10 having the above-mentioned arrangement, the clutch is tightened or engaged and released or disengaged in the following manner. A condition shown in FIG. 1 is a clutch released condition in which the separator plates 2 are separated from the wet type friction plates 3. In the released condition, the piston 6 abuts against the inner surface of the closed end portion of the clutch case 1 by a biasing force of a return spring (not shown).

From this condition, in order to tighten or engage the clutch, hydraulic pressure is supplied to the hydraulic chamber 11 defined between the piston 6 and the clutch case 1. As the hydraulic pressure is increased, the piston 6 is shifted to the right in FIG. 1 in opposition to the biasing force of the return spring (not shown), thereby closely contacting the separator plates 2 with the wet type friction plates 3.

After the engagement, to release the clutch again, the hydraulic pressure is released from the hydraulic chamber 11. When the hydraulic pressure is released, by the biasing force of the return spring (not shown), the piston 6 is shifted until it abuts against the closed end portion of the clutch case 1. In this way, the clutch is released or disengaged.

### First Embodiment

FIG. 2 is a front view of a wet type friction plate according to a first embodiment of the present invention. The wet type friction plate 3 has a friction surface 25 formed by sticking or fixing a substantially annular friction material 21 to a substantially annular core plate 20 by an adhesive or the like. The core plate 20 is provided at its inner periphery with splines 20a adapted to be engaged by the spline portion 5 of the hub 4.

As shown, a plurality of grooves 22 equidistantly spaced apart from each other along a circumferential direction is formed in the friction material 21 by a press or the like. The groove 22 is defined between two opposed sides 27 and 28 of the friction material 21. The groove 22 is provided with a radial intermediate portion 26 having a width greater than widths of opening portions 23 and 24 formed at inner and outer diameter portions, respectively. The circumferential width of the opening portion 23 is the same as that of the opening portion 24.

In this way, by designing a groove configuration so that the width of the groove is increased from the inner and outer diameter portions of the friction surface 25 toward the intermediate portion in an arc fashion, as the number of rotations or revolutions is increased, negative pressure is generated in the groove 22 to take in lubricating oil from the inner diameter portion or the outer diameter portion to the groove 22, and the taken-in lubricating oil is supplied from the groove 22 to the friction surface 25 effectively, thereby efficiently eliminating friction heat generated during the engagement.

### Second Embodiment

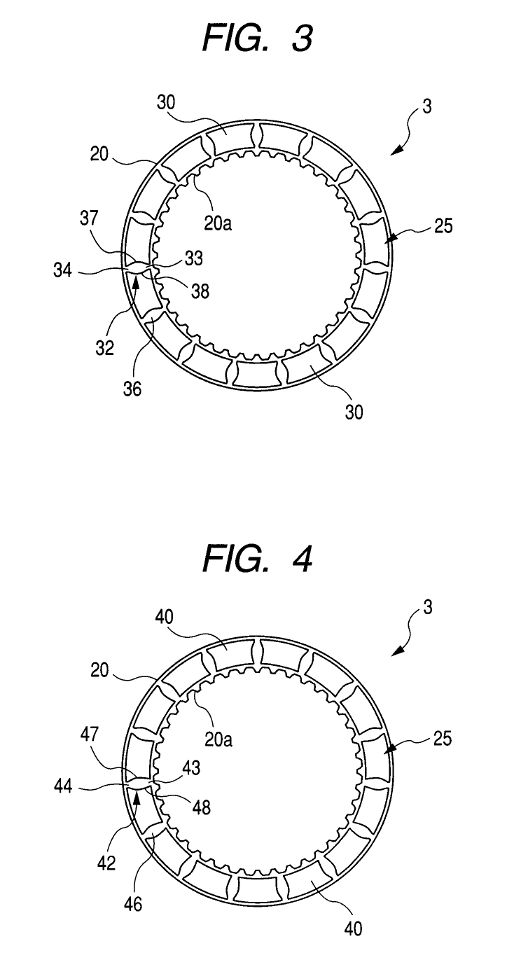

FIG. 3 is a front view of a wet type friction plate according to a second embodiment of the present invention. Unlike to the first embodiment, the friction material is constituted by discrete friction material segments. The wet type friction plate 3 has a friction surface 25 formed by fixing a plurality of friction material segments 30 having the same configuration to a substantially annular core plate 20 in an annular arrangement by an adhesive or the like.

As shown, a plurality of grooves 32 equidistantly spaced apart from each other along a circumferential direction is formed between the friction material segments 30. The groove 32 is defined between two opposed sides 37 and 38 of the friction material segments 30. The groove 32 is provided with a radial intermediate portion 36 having a width greater than widths of opening portions 33 and 34 formed at inner and outer diameter portions, respectively. The circumferential width of the opening portion 33 is the same as that of the opening portion 34.

Also in the second embodiment, the same effect as that of the first embodiment can be obtained.

### Third Embodiment

FIG. 4 is a front view of a wet type friction plate according to a third embodiment of the present invention. Similar to the second embodiment, the friction material is constituted by discrete friction material segments. The wet type friction plate 3 has a friction surface 25 formed by fixing a plurality of friction material segments 40 having the same configuration to a substantially annular core plate 20 in an annular arrangement by an adhesive or the like.

As shown, a plurality of grooves 42 equidistantly spaced apart from each other along a circumferential direction is formed between the friction material segments 40. The groove 42 is defined between two opposed sides 47 and 48 of the friction material segments 40. The groove 42 is provided with a radial intermediate portion 46 having a width greater than widths of opening portions 43 and 44 formed at inner and outer diameter portions, respectively.

Unlike to the first and second embodiments, in the third embodiment, the width of the inner diameter portion is different from the width of the outer diameter portion. As shown in FIG. 4, the circumferential width of the opening portion 43 of the inner diameter portion is greater than the circumferential width of the opening portion 44 of the outer diameter portion.

By setting the widths in this way, in the third embodiment, the same effect as that of the first embodiment can be obtained, and the following another effects can also be obtained. Since the circumferential width of the opening portion 43 is greater than the circumferential width of the opening portion 44, a greater amount of lubricating oil can be taken in from the inner diameter portion. Further, in association with the lubricating path, optimum lubrication of the friction surface 25 can be achieved.

### Fourth Embodiment

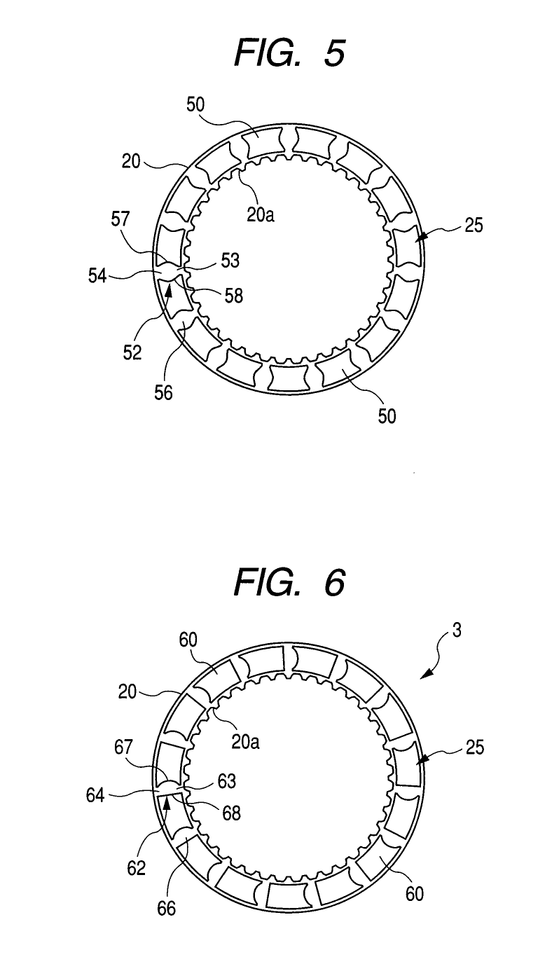

FIG. 5 is a front view of a wet type friction plate according to a fourth embodiment of the present invention. Similar to the second embodiment, the friction material is constituted by discrete friction material segments. The wet type friction plate 3 has a friction surface 25 formed by fixing a plurality of friction material segments 50 having the same configuration to a substantially annular core plate 20 in an annular arrangement by an adhesive or the like.

As shown, a plurality of grooves 52 equidistantly spaced apart from each other along a circumferential direction is formed between the friction material segments 50. The groove 52 is defined between two opposed sides 57 and 58 of the friction material segments 50. The groove 52 is provided with a radial intermediate portion 56 having a width greater than widths of opening portions 53 and 54 formed at inner and outer diameter portions, respectively.

Similar to the third embodiment, in the fourth embodiment, although the width of the inner diameter portion differs from the width of the outer diameter portion, a reverse arrangement is adopted. That is to say, as shown in FIG. 5, the circumferential width of the opening portion 53 of the inner diameter portion is smaller than the circumferential width of the opening portion 54 of the outer diameter portion.

By setting the widths in this way, in the fourth embodiment, the same effect as that of the first embodiment can be obtained, and the following another effects can also be obtained. Since the circumferential width of the opening portion 54 is greater than the circumferential width of the opening portion 53, a greater amount of lubricating oil can be taken in from the outer diameter portion. Further, in association with the lubricating path, optimum lubrication of the friction surface 25 can be achieved.

### Fifth Embodiment

FIG. 6 is a front view of a wet type friction plate according to a fifth embodiment of the present invention. The friction material is constituted by discrete friction material segments. The wet type friction plate 3 has a friction surface 25 formed by fixing a plurality of friction material segments 60 having the same configuration to a substantially annular core plate 20 in an annular arrangement by an adhesive or the like.

As shown, a plurality of grooves 62 equidistantly spaced apart from each other along a circumferential direction is formed between the friction material segments 60. The groove 62 is defined between two opposed sides 67 and 68 of the friction material segments 60. The groove 62 is provided with a radial intermediate portion 66 having a width greater than widths of opening portions 63 and 64 formed at inner and outer diameter portions, respectively. The circumferential width of the opening portion 63 is the same as that of the opening portion 64.

Unlike to the above-mentioned first to fourth embodiments, in the illustrated embodiment, the side 67 among the sides for defining the groove 62 has an arc configuration, whereas the side 68 has a straight configuration. Also with this arrangement, since the intermediate portion 66 of the groove 62 has the maximum width, the lubricating oil taking-in ability is substantially the same as those in the afore-mentioned embodiments. Accordingly, also in the fifth embodiment, the same effect as that of the first to fourth embodiments can be obtained.

### Sixth Embodiment

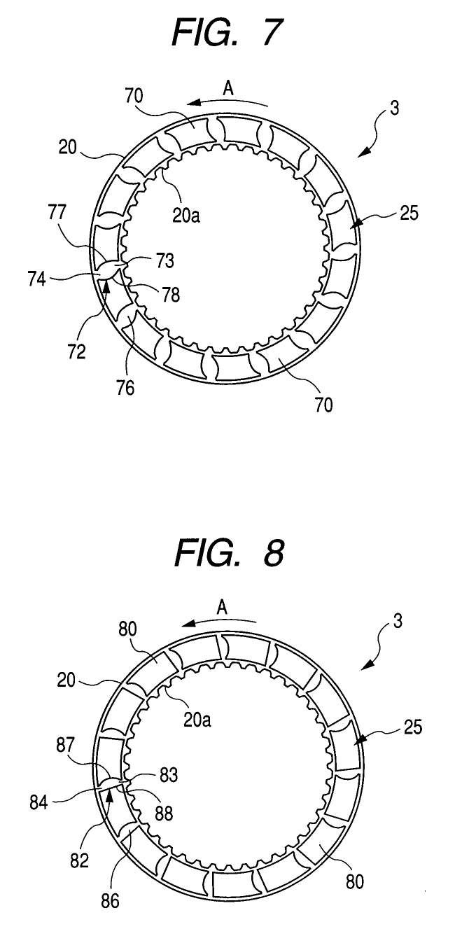

FIG. 7 is a front view of a wet type friction plate according to a sixth embodiment of the present invention. The friction material is constituted by discrete friction material segments. The wet type friction plate 3 has a friction surface 25 formed by fixing a plurality of friction material segments 70 having the same configuration to a substantially annular core plate 20 in an annular arrangement by an adhesive or the like.

As shown, a plurality of grooves 72 equidistantly spaced apart from each other along a circumferential direction is formed between the friction material segments 70. The groove 72 is defined between two opposed sides 77 and 78 of the friction material segments 70. The groove 72 is provided with a radial intermediate portion 76 having a width greater than widths of opening portions 73 and 74 formed at inner and outer diameter portions, respectively.

In the illustrated embodiment, the width of the inner diameter portion of the groove 72 is the same as the width of the outer diameter portion. That is to say, as shown in FIG. 7, the circumferential width of the opening portion 73 of the inner diameter portion is the same as the circumferential width of the opening portion 74 of the outer diameter portion.

The sixth embodiment is the same as the afore-mentioned first to fourth embodiments in the point that the sides 77 and 78 of the groove 72 have the arc configurations. However, the difference is that the groove 72 is inclined with respect to a rotational direction A of the friction plate 3. In the afore-mentioned embodiments, although the groove extends in a direction substantially perpendicular to the circumferential direction i.e. the rotational direction of the friction plate 3, in the illustrated embodiment, the groove 72 is inclined by a predetermined angle along the rotational direction of the friction plate 3.

By inclining the grooves with respect to the rotational direction A of the friction plate 3, the efficiency for taking in the lubricating oil is more enhanced.

### Seventh Embodiment

FIG. 8 is a front view of a wet type friction plate according to a seventh embodiment of the present invention. The friction material is constituted by discrete friction material segments. The wet type friction plate 3 has a friction surface 25 formed by fixing a plurality of friction material segments 80 having the same configuration to a substantially annular core plate 20 in an annular arrangement by an adhesive or the like.

As shown, a plurality of grooves 82 equidistantly spaced apart from each other along a circumferential direction is formed between the friction material segments 80. The groove 82 is defined between two opposed sides 87 and 88 of the friction material segments 80. The groove 82 is provided with a radial intermediate portion 86 having a width greater than widths of opening portions 83 and 84 formed at inner and outer diameter portions, respectively.

In the illustrated embodiment, the width of the inner diameter portion of the groove 82 is the same as the width of the outer diameter portion. That is to say, as shown in FIG. 8, the circumferential width of the opening portion 83 of the inner diameter portion is the same as the circumferential width of the opening portion 84 of the outer diameter portion.

Similar to the fifth embodiment shown in FIG. 6, in the seventh embodiment, the side 87 among both sides 87 and 88 of the groove 82 has an arc configuration, whereas the opposed side 88 has a straight configuration. Also with this arrangement, since the intermediate portion 86 of the groove 82 has the maximum width, the lubricating oil taking-in ability is substantially the same as those in the afore-mentioned embodiments. Accordingly, also in the seventh embodiment, the same effect as that of the afore-mentioned embodiments can be obtained.

Further, similar to the sixth embodiment, in the illustrated embodiment, the groove 82 is inclined with respect to a rotational direction A of the friction plate 3. In the afore-mentioned embodiments, although the groove extends in a direction substantially perpendicular to the circumferential direction i.e. the rotational direction of the friction plate 3, in the illustrated embodiment, similar to the sixth embodiment, the groove 82 is inclined by a predetermined angle along the rotational direction of the friction plate 3.

By inclining the grooves with respect to the rotational direction A of the friction plate 3, the efficiency for taking in the lubricating oil is more enhanced.

In the afore-mentioned embodiments, various alterations and modifications can be made without departing from the scope of the present invention. For example, although the friction material segments are used in the embodiments other than the first embodiment, similar to the first embodiment, in all of these embodiments, an annular friction material may be used, and grooves may be formed by a press or the like.

Further, it should be noted that the arrangement in which the width of the groove at the inner diameter side differs from the width of the groove at the outer diameter side as shown in the third and fourth embodiments can be applied to the remaining embodiments other than the third and fourth embodiments. Further, a plurality of intermediate portions having the maximum width may be provided along the radial direction of the groove.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-068556, filed Mar. 16, 2007, which is hereby incorporated by reference herein in its entirety.

What is claimed is:

1. A wet type friction plate having a friction surface formed by fixing a friction material to a substantially annular core plate in an annular arrangement, wherein:
a plurality of grooves extending through from an inner diameter portion to an outer diameter portion is formed in said friction surface; and at least one of both side portions of said friction material defining said groove is formed as an arc configuration; and said groove has a radial intermediate portion having a width greater than those of said inner diameter portion and said outer diameter portion.

2. A wet type friction plate according to claim 1, wherein said friction material is constituted by friction material segments, and said groove is formed between said friction material segments.

3. A wet type friction plate according to claim 1, wherein said friction material is constituted by an annular friction material, and said groove is formed in a surface of said friction material.

4. A wet type friction plate according to claim 1, wherein a width of said inner diameter portion of said groove is greater than a width of said outer diameter portion.

5. A wet type friction plate according to claim 1, wherein a width of said outer diameter portion of said groove is greater than a width of said inner diameter portion.

6. A wet type friction plate according to claim 1, wherein one side portion of said groove is inclined with respect to a rotational direction of said wet type friction plate.
